(19) United States
(12) Patent Application Publication
(10) Pub. No.: US 2023/0217266 A1
(43) Pub. Date: Jul. 6, 2023

(54) MOBILE PLATFORM CLUSTERS FOR COMMUNICATIONS CELL TRANSMISSION

(71) Applicant: KYTHERA SOFTWARE, INC., Bethesda, MD (US)

(72) Inventor: Jeffrey Freedman, Laurel, MD (US)

(21) Appl. No.: 18/091,018

(22) Filed: Dec. 29, 2022

Related U.S. Application Data
(60) Provisional application No. 63/295,049, filed on Dec. 30, 2021.

(51) Int. Cl. H04W 16/28; H04W 52/52

(52) U.S. Cl. CPC H04W 16/28; H04W 52/52; H04W 84/06

(57) ABSTRACT

A method includes determining a respective position of each of one or more mobile platforms of a plurality of mobile platforms forming a cluster. The mobile platforms include aircraft or spacecraft. The method includes, based on the respective positions of the one or more mobile platforms of the cluster, controlling each mobile platform of the one or more mobile platforms to transmit a respective signal. A combination of the respective signals form a communications cell that is spatially localized at a location of a target terrestrial device, the communications cell configured to provide communications coverage for the target terrestrial device.

### CROSS-REFERENCE TO RELATED APPLICATIONS

This application claims the benefit under 35 U.S.C. § 119(e) of the filing date of U.S. patent application Ser. No. 63/295,049, filed on Dec. 30, 2021, the entirety of which is incorporated herein by reference.

### FIELD OF THE DISCLOSURE

The present disclosure relates to wireless signal reception and transmission using clusters of mobile platforms.

### BACKGROUND

Some communications systems, such as satellite communications systems, provide communication channels for terrestrial devices. A target area for a satellite communications systems can be covered by analog and/or digital communications beams for data transmission.

### SUMMARY

Some aspects of the present disclosure describe a method. The method includes determining a respective position of each of one or more mobile platforms of a plurality of mobile platforms forming a cluster. The mobile platforms include aircraft or spacecraft. The method includes, based on the respective positions of the one or more mobile platforms of the cluster, controlling each mobile platform of the one or more mobile platforms to transmit a respective signal. A combination of the respective signals form a communications cell that is spatially localized at a location of a target terrestrial device, the communications cell configured to provide communications coverage for the target terrestrial device.

This and other described methods can have one or more of at least the following characteristics.

In some implementations, controlling each mobile platform of the one or more mobile platforms to transmit the respective signal includes determining, for each signal of the respective signals, a corresponding gain and phase. The gain and the phase of each signal are combined to cause the respective signals to form a beam spatially localized at the location of the target terrestrial device.

In some implementations, the corresponding gain and phase are determined such that the beam has a null at a location associated with another terrestrial device.

In some implementations, the other terrestrial device shares a communications cell frequency with the target terrestrial device.

In some implementations, determining, for each signal, the corresponding gain and phase includes: receiving, at a gateway device, phase data characterizing reception of an uplink signal received at the cluster from the target terrestrial device; based on the phase data, determining the location of the target terrestrial device; based on the location of the target terrestrial device and the respective positions of the one or more mobile platforms, determining the corresponding gain and phase of each signal of the respective signals; and transmitting, to the cluster, commands to cause the one or more mobile platforms to transmit the respective signals having the corresponding gains and phases.

In some implementations, the method includes: receiving, at the one or more mobile platforms, from a gateway device, data for the target terrestrial device. The respective signals encode the data for reception by the target terrestrial device.

In some implementations, the method includes: receiving, at the cluster, from the target terrestrial device, an uplink signal; based on respective phases of the uplink signal as received at individual mobile platforms of the cluster, determining an angle of arrival of the uplink signal with respect to the cluster; and based on the angle of arrival, determining the location of the target terrestrial device.

In some implementations, the location of the target terrestrial device is a future location, and determining the location includes predicting the future location using a Kalman filter method.

In some implementations, the one or more mobile platforms are one or more first mobile platforms, and the communications cell is a first communications cell. The method includes: controlling each mobile platform of one or more second mobile platforms of the plurality of mobile platforms to transmit a respective signal. A combination of the respective signals from the one or more second mobile platforms form a second communications cell that is spatially localized at a location of a second terrestrial device, the second communications cell configured to provide communications coverage for the second terrestrial device.

In some implementations, at least one mobile platform of the plurality of mobile platforms is included in the one or more first mobile platforms and in the one or more second mobile platforms.

In some implementations, the first communications cell and the second communications cell spatially overlap. The first communications cell is defined by a first beam having a first frequency, and the second communications cell is defined by a second beam having a second frequency that is different from the first frequency.

In some implementations, the first communications cell and the second communications cell are spatially non-overlapping, the first communications cell is defined by a first beam having a particular frequency, and the second communications cell is defined by a second beam having the particular frequency.

In some implementations, the plurality of mobile platforms forming the cluster includes at least ten mobile platforms, and the at least ten mobile platforms are spatially distributed within a sphere having a diameter of at least 500 m.

In some implementations, the one or more mobile platforms are a subset of the plurality of mobile platforms forming the cluster.

In some implementations, the method includes selecting the cluster for signal transmission to the target terrestrial device from among a plurality of clusters. Selecting the cluster is based on at least one of: a signal-to-noise ratio of an uplink signal received at the cluster from the target terrestrial device, an estimate of downlink multipath fading, or an estimated line-of-sight from the cluster to the target terrestrial device.

In some implementations, the plurality of mobile platforms include satellites.

In some implementations, the plurality of mobile platforms include a leader platform, and the method includes: receiving, at the leader platform, commands from a gateway device; and relaying the commands to the one or more mobile platforms, the commands causing the one or more mobile platforms to transmit the respective signals.

In some implementations, the method includes, determining, by a gateway device, the location of the target terrestrial device; determining, by the gateway device, characteristics of the respective signals that cause the respective signals to form the communications cell; and sending, to the one or more mobile platforms, from the gateway device, commands based on the characteristics of the respective signals, the commands causing the one or more mobile platforms to transmit the respective signals.

Some aspects of this disclosure describe a system. The system includes a cluster formed by a plurality of mobile platforms, the plurality of mobile platforms including aircraft or spacecraft; and a gateway device. The gateway device is configured to: determine a respective position of one or more mobile platforms of the plurality of mobile platforms; and based on the respective positions of the one or more mobile platforms of the cluster, control each mobile platform of the one or more mobile platforms to transmit a respective signal. A combination of the respective signals form a communications cell that is spatially localized at a location of a target terrestrial device, the communications cell configured to provide communications coverage for the target terrestrial device.

This and other described systems can have one or more of at least the following characteristics.

In some implementations, controlling each mobile platform of the one or more mobile platforms to transmit the respective signal includes: determining, for each signal of the respective signals, a corresponding gain and phase. The gain and the phase of each signal are combined to cause the respective signals to form a beam spatially localized at the location of the target terrestrial device.

In some implementations, the corresponding gain and phase are determined such that the beam has a null at a location associated with another terrestrial device.

In some implementations, the other terrestrial device shares a communications cell frequency with the target terrestrial device.

In some implementations, determining, for each signal, the corresponding gain and phase includes: receiving phase data characterizing reception of an uplink signal received at the cluster from the target terrestrial device; based on the phase data, determining the location of the target terrestrial device; based on the location of the target terrestrial device and the respective positions of the one or more mobile platforms, determining the corresponding gain and phase of each signal of the respective signals; and transmitting, to the cluster, commands to cause the one or more mobile platforms to transmit the respective signals having the corresponding gains and phases.

In some implementations, the gateway device is configured to transmit, to the one or more mobile platforms, data for the target terrestrial device. The respective signals encode the data for reception by the target terrestrial device.

In some implementations, the gateway device is configured to: based on respective phases of an uplink signal as received at individual mobile platforms of the cluster, determine an angle of arrival of the uplink signal with respect to the cluster; and based on the angle of arrival, determine the location of the target terrestrial device.

In some implementations, the location of the target terrestrial device is a future location, and determining the location includes predicting the future location using a Kalman filter method.

In some implementations, the one or more mobile platforms are one or more first mobile platforms. The communications cell is a first communications cell. The gateway device is configured to control each mobile platform of one or more second mobile platforms of the plurality of mobile platforms to transmit a respective signal. A combination of the respective signals from the one or more second mobile platforms form a second communications cell that is spatially localized at a location of a second terrestrial device, the second communications cell configured to provide communications coverage for the second terrestrial device,

In some implementations, the first communications cell and the second communications cell spatially overlap, the first communications cell is defined by a first beam having a first frequency, and the second communications cell is defined by a second beam having a second frequency that is different from the first frequency; or, the first communications cell and the second communications cell are spatially non-overlapping, the first communications cell is defined by a first beam having a particular frequency, and the second communications cell is defined by a second beam having the particular frequency.

In some implementations, at least one mobile platform of the plurality of mobile platforms is included in the one or more first mobile platforms and in the one or more second mobile platforms.

In some implementations, the plurality of mobile platforms forming the cluster includes at least ten mobile platforms, and the at least ten mobile platforms are spatially distributed within a sphere having a diameter of at least 500 m.

In some implementations, the gateway device is configured to select the cluster for signal transmission to the target terrestrial device from among a plurality of clusters. Selecting the cluster is based on at least one of: a signal-to-noise ratio of an uplink signal received at the cluster from the target terrestrial device, an estimate of downlink multipath fading, or an estimated line-of-sight from the cluster to the target terrestrial device.

The details of one or more implementations are set forth in the accompanying drawings and the description below. Other aspects, features and advantages will be apparent from the description and drawings, and from the claims.

### BRIEF DESCRIPTION OF THE DRAWINGS

FIG. 1 is a diagram illustrating an example of communication between a mobile platform cluster, terrestrial devices, and a gateway device.

FIG. 2 is a diagram illustrating an example of beamforming by a mobile platform cluster.

FIG. 3 is a contour plot showing simulated results of beamforming to form a communications cell.

FIG. 4 is a diagram illustrating an example of terrestrial device location determination.

FIG. 5 is a diagram illustrating an example of cluster selection.

FIG. 6 is a diagram illustrating an example of a process according to some implementations of the present disclosure.

FIG. 7 is a plot illustrating examples of scaling for mobile platform clusters.

### DETAILED DESCRIPTION

This disclosure relates to the use of clusters of mobile platforms to produce communication cells for signal transmission (e.g., radio/cellular signal transmission) to individual terrestrial devices. A mobile platform in this context can be an aerial platform, such as a satellite, a drone, an unmanned aerial vehicle (UAV), a high-altitude communications balloon, or a terrestrial platform, such as a land vehicle (e.g., a truck) or a marine vehicle (e.g., a ship). In some implementations, a cluster of mobile platforms is controlled to behave like a single signal transmitter/receiver, to generate a cell is spatially localized on a location of a specific terrestrial device. In some implementations, the cell can be referred to as a “private” cell, because the cell is formed to target a particular device and/or a relatively limited area, as opposed to typical 4G/5G cells, which often cover several square miles and provide connectivity to many devices. As the terrestrial device moves, the private cell can also move by appropriate configuration of signals transmitted by the mobile platforms of the cluster. The use of cluster-generated private cells can allow for a reduction in net power associated with signal transmission, an increase in bandwidth, and/or an increase in capacity (e.g., an increase in total data throughput and/or an increase in a number of serviced devices) for a given number of mobile platforms and/or compared to other arrangements.

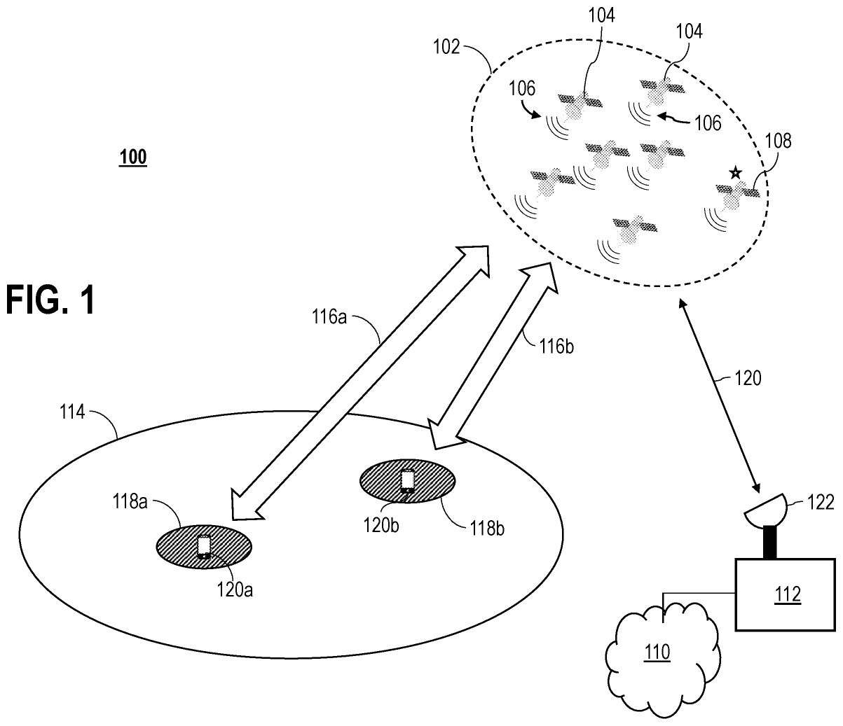

FIG. 1 illustrates an example of a system 100 including a cluster 102 of multiple mobile platforms, such as mobile platforms 104. The mobile platforms 104 can be of one or more types, for example, aircraft and/or spacecraft. Types of aircraft can include, for example, drones, UAVs, balloons, and/or airplanes. Types of spacecraft can include, for example, microsatellites, nanosatellites, and/or other types of satellites, which can be in low earth orbit (LEO), medium earth orbit (MEO), and/or geosynchronous orbit (GEO).

The cluster 102 (e.g., one or more mobile platforms 104 in the cluster) is in wireless communication with a gateway device 112, such as a terrestrial computer system. In some implementations, the gateway device 112 is a satellite gateway. This can be the case, for example, when the mobile platforms 104 are satellites.

Signals 120 can be transmitted between the gateway device 112 and the cluster 102, e.g., using one or more transceivers/antennas 122 coupled to the gateway device. The signals 120 can include, for example, radio frequency (RF) signals, microwave signals, infrared signals, and/or optical signals, such as for laser-based communication. The gateway device 112 is communicatively coupled to a network 110, which can include a terrestrial network (e.g., the Internet and/or an intranet) and/or a space-based network. In some implementations, communication with the gateway device 112 is performing via one or more intermediate/relay devices, which can include terrestrial relay devices, aerial relay devices, and/or space-based relay devices. A cluster 102 may be in communication with multiple gateway devices 112, e.g., corresponding to different coverage regions or portions of coverage regions.

In some implementations, communications between the cluster 102 and the gateway device 112 involves each mobile platform 104 independently communicating with the gateway device 112, e.g., transmitting signals to and receiving signals from the gateway device. In some implementations, communications between the cluster 102 and the gateway device 112 involves a subset of the mobile platforms 104 in the cluster 102 communicating with the gateway device 112, acting as relays/intermediaries for data to/from other mobile platforms 104 in the cluster that do not communicate directly with the gateway device 112. For example, in some implementations, the cluster 102 includes a leader mobile platform 108. Other mobile platforms 104 transmit data to the leader mobile platform 108, which transmits the data or a modified version thereof to the gateway device 112. Likewise, the leader mobile platform 108 receives transmissions from the gateway device 112 and transmits data from the transmissions to one or more of the other mobile platforms 104. In some implementations, the cluster 102 does not include the leader mobile platform 108.

The gateway device 112 can act as a node to obtain/determine information about the cluster 102, perform corresponding calculations, and provide commands and data to the cluster 102 to facilitate signal reception/transmission by the cluster 102. In some implementations, the gateway device 112 performs interpretation/analysis of signals received at the cluster 102 from terrestrial devices. In some implementations, the gateway device 112 demodulates pilot signals from terrestrial devices. In some implementations, the gateway device 112 has greater computing resources than the mobile platforms 104, such that the gateway device 112 is better-suited to perform the calculations described in this disclosure, such as determining locations of terrestrial devices, performing beamforming to facilitate formation of private cells, and selecting a cluster to use for communication. However, in some implementations, any or all of these functions may be performed by another device/system, such as by one or more mobile platforms 104 themselves. In some implementations, the gateway device 112 is or includes an aerial and/or space-based computing system.

The mobile platforms 104 can communicate with one another and/or with the gateway device to transfer command signals, data from the gateway device 112, and/or data from terrestrial devices, and/or to allow for the determination of respective positions of each mobile platform 104. In the case of satellite mobile platforms, an inter-satellite link (ISL) protocol can be used, e.g., an RF, microwave, and/or optical ISL protocol. RF, microwave, and/or optical communication can also be used when the mobile platforms are other types of devices, such as airborne UAVs.

The gateway device 112 can be configured to determine respective positions of each mobile platform 104, in relative coordinates and/or in absolute coordinates. Absolute coordinates may include, for example, latitude, longitude, and altitude, or coordinates of each mobile platform 104 with respect to a fixed terrestrial position. Relative coordinates may include, for example, positions of each mobile platform 104 with respect to a particular one of the mobile platforms 104 (e.g., a leader mobile platform 108). In some implementations, the mobile platforms 104 transmit positioning signals (e.g., RF signals) to one another, allowing for the determination of the relative positions of each mobile platform 104 to within a fraction of the wavelengths of the positioning signals. In some implementations, the gateway device 112 receives data from navigation sensors in each mobile platform 104, such as Global Navigation Satellite System (GNSS) data, Ultra Wide Band (UWB) data, vision data, and/or radar data. One or more methods, such as a Real-Time Kinematic (RTK) method, can be applied to determine the relative positions. The determination of the respective positions can be a calibration process.

The cluster 102 is controlled (e.g., at least partially by the gateway device 112) to send and receive signals 116a from one or more terrestrial devices 120a, 120b (referred to collectively as terrestrial devices 120). The terrestrial devices 120 can include, for example, cellular phones, satellite phones, various types of computing devices (e.g., wearable devices, smartphones, tablets, and portable or fixed computers), ground stations, network base stations, vehicles (e.g., cars, trucks, and ships), and/or any other type of device capable of receive signals from and transmitting signals to the cluster 102.

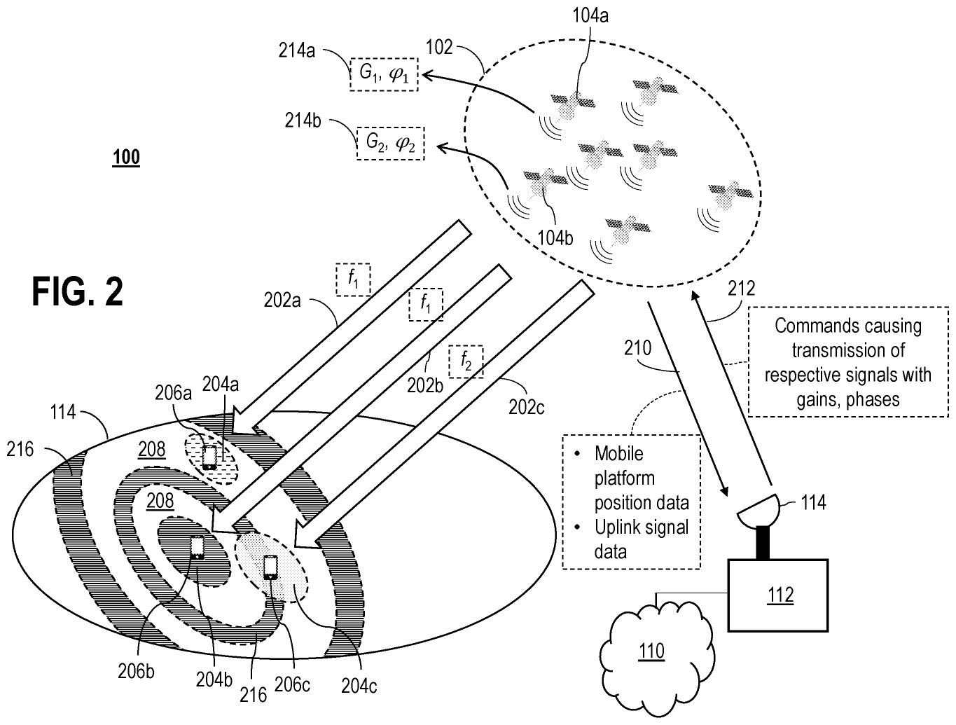

As shown in FIG. 1, each mobile platform 104 transmits a respective individual signal 106. The individual signals 106 are configured (e.g., based on respective gains/phases, as described in reference to FIG. 2) to collectively transmit localized beams (carrying downlink data) to the respective locations of the terrestrial devices 120 in an overall coverage region 114. The coverage region 114 defines an area in which the cluster 102 is capable of forming private cells. The localized beams form respective private cells 118a, 118b (referred to collectively as private cells 118) at the respective locations of the terrestrial devices 120. A private cell 118 is a region of high-gain transmission from one of the localized beams, the gain being sufficiently high to allow for high-fidelity signal reception by the corresponding terrestrial device 120, e.g., with a one-to-one correspondence between the private cell 118 and the corresponding terrestrial device 120.

With sufficient spatial, temporal, and/or channel (frequency) differentiation between private cells (as described in further detail below with respects to FIG. 2), and given a sufficient number of mobile platforms 104 in the cluster 102, the cluster 102 can provide a large number of private cells simultaneously to a large number of terrestrial devices. The number of private cells can be in the range from hundreds to thousands or even millions, and the number of terrestrial devices can correspondingly be in the hundreds to thousands or millions. Because each private cell 118 is spatially localized, interference between signals transmitted to multiple, spatially-separated terrestrial devices 120 (e.g., devices receiving data at the same frequency and at the same time) can be reduced or eliminated. Moreover, data security is enhanced, because devices outside each private cell 118 will find it difficult or impossible to detect enough of the downlink signal of the private cell 118 to snoop on the downlink signal.

FIG. 2 illustrates an example of a private cell generation using the system 100. As shown, the cluster 102 transmits gateway downlink data 210 to the gateway device 112. The gateway downlink data 210 includes mobile platform position data indicative of respective positions of two or more of the mobile platforms 104 (e.g., a subset of, or all of, the mobile platforms 104). The mobile platform position data can be the positions themselves (e.g., in a local and/or global coordinate system), and/or the mobile platform position data can be data based on which the gateway device 112 can determine the positions. For example, in some implementations, each mobile platform 104 broadcasts, for receipt by the other mobile platforms 104, a respective positioning signal including an identifier of the mobile platform 104. The gateway device 112 receives data characterizing the positioning signals as-received by the mobile platforms 104 (e.g., a strength and/or phase of mobile platform 104a's positioning signal as-received by one or more other mobile platforms 104) and, based on this data, determines respective positions of the mobile platforms 104.

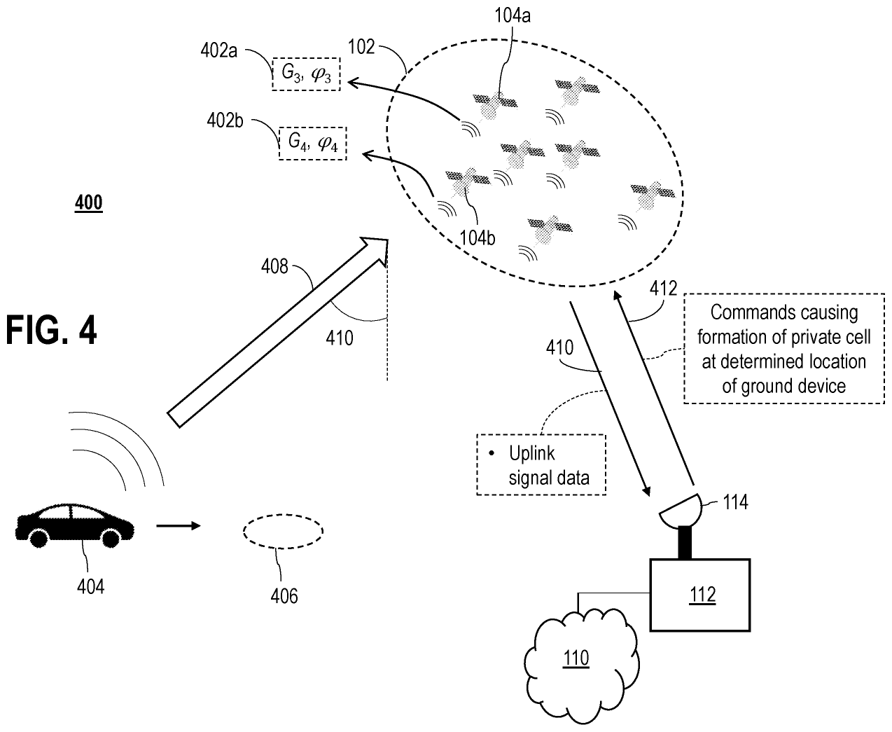

The gateway downlink data 210 further includes data characterizing uplink signals received by the cluster 102 from one or more terrestrial devices 206a, 206b, 206c (referred to collectively as terrestrial devices 206). In some implementations, one or more of the terrestrial devices 206a, 206b, 206c are similar to the terrestrial devices 120a or 120b. The gateway device 112 is configured to use this data to determine respective locations (e.g., current and/or future locations) of each terrestrial device 206). Further information on terrestrial device location determination is provided in reference to FIG. 4.

Based on (i) the positions of the mobile platforms 104 and (ii) the locations of the terrestrial devices 206), the gateway device 112 performs beamforming calculations to determine one or more characteristics of individual signals 214a, 214b (referred collectively as individual signals 214) to be emitted by each mobile platform 104 such that the individual signals 214 form localized beams 202a, 202b, 202c (referred to collectively as localized beams 202) that form private cells localized at the locations of each terrestrial device 206. The gateway device 112 transmits gateway uplink data 212 that includes commands to cause transmission of the individual signals 214. For example, the gateway uplink data 212 can indicate that mobile platform 104a is to transmit an individual signal 214a with gain G₁ and phase φ₁, and that mobile platform 104b is to transmit an individual signal 214b with gain G₂ and phase φ₂. In some implementations, the gateway uplink data 212 provides the individual signal 214 for each mobile platform 104 to transmit, and the gain and phase of the individual signal 214 are characteristics of the individual signal 214 and indicated by provision of the individual signal 214, without being separately (e.g., explicitly) indicated.

For example, in some implementations, the gateway uplink data 212 indicates a gain Gᵢ and/or phase φᵢ for each individual signal 214. The gain and/or phase are such that the individual signals 214 interfere constructively and destructively to obtain the desired spatial localization of each private cell. To determine the gain and/or phase, the gateway device 112 can apply one or more suitable beamforming algorithms/methods. For example, beamforming can include solving electromagnetic equations to form individual signals 214 that add coherently at the location of a desired private cell, and that interfere destructively at desired side-lobes.

The content of each localized beam 202 (e.g., the data encoded by/modulated in each localized beam 202) includes data for reception by the terrestrial device 206 targeted by the localized beam, referred to as “downlink data.” The modulation can be any suitable modulation, e.g., 4G or 5G modulation. The downlink data can include, for example, digital data (e.g., representing text, audio, images, and/or video) and/or analog data (e.g., analog voice signals for voice calls). Accordingly, the individual signals 214 themselves carry, wholly or partially, the downlink data. The downlink data can be provided by the gateway device 112 in the gateway uplink data 212. In some implementations, the downlink data is wholly or partially provided to the gateway device over the network 110. In some implementations, for each of two or more of the mobile platforms 104 that transmit individual signals 214 to form a given localized beam 202, the individual signals 214 are identical except for the gain and/or phase of each individual signal 214. For example, in some implementations, for each terrestrial device 206, each mobile platform 104 transmits a corresponding signal that matches the corresponding signal transmitted by other mobile platform(s) 104 (e.g., encodes the downlink data), except that the gain and/or phase of the signal may be different between each mobile platform 104. The total signal transmitted by each mobile platform 104 may then be the sum of the mobile platform 104's signals for multiple terrestrial devices 206.The individual signals 214 encode the downlink data such that the downlink data is included in the beams 202 and received by the terrestrial devices 206.

The cluster 102 may be described as transmitting a single beam to the cluster's coverage region 114, the single beam carrying data for multiple terrestrial devices 120 and forming multiple private cells; the localized beams 202 may not be individually discernible/separable in the single beam. In some implementations, each individual signal 214, at any given time, may encode data corresponding to multiple localized beams 202. Each individual signal 214 can be a combination of multiple signals carrying respective data for transmission to respective terrestrial devices 106, the combined signals summed with respective gains and/or phases (e.g., determined by the gateway device 112) to obtain the individual signal 214 transmitted by the mobile platform 104. In turn, the individual signals 214 sum to obtain private cells localized at each terrestrial device 106, each private cell predominantly composed of the particular data intended for the corresponding terrestrial device.

The localized beams 202 form respective private cells for each terrestrial device 206. Based on the gains and/or phases of each individual signal 214, the private cells are localized to reduce or eliminate simultaneous private cell overlap between private cells sharing the same channel (same downlink frequency).

The set of mobile platforms 104 that participate in forming a given beam 202 can be a subset of all the mobile platforms in the cluster 102, or can be all the mobile platforms in the cluster. In some implementations, different subsets of the cluster 102 (overlapping or non-overlapping subsets) participate in forming different beams 202. For example, based on a determined target gain, a determined target location for the private cell, and/or, in some implementations, one or more other constraints (e.g., side lobe suppression over devices receiving data at the same frequency and, in some implementations, at the same time), the baseband device 112 can determine a subset of the mobile platforms 104 of the cluster 102 that can form a beam to provide the target gain at the target location, subject to any constraints.

For example, as shown in FIG. 2, a private cell 204b is spatially localized at the location of terrestrial device 204b. The indicated private cell 204b can be the main lobe of the private cell 204b, e.g., the region receiving the highest signal intensity from the beam 202b carrying downlink data for terrestrial device 204b. The beam 202b is associated with a channel, e.g., has a downlink frequencyfi, such as the center frequency of the channel. The channel represents a division of an overall frequency band usable by the cluster 102, such as the 6 GHz Band or the Ku Band. For example, in some implementations that employ the 6 GHz Band, each channel is a 20 MHz portion of the band. For example, downlink data for the terrestrial device 204b is encoded in the beam 202b (in modulations of the beam 202b), which has carrier frequencyfi. The channel/frequency for each beam 202 can be determined in a handshake procedure between each terrestrial device 206 and the cluster 102 and/or the gateway device 112.

In some cases, each beam 202 may produce, in addition to a localized private cell, such as the private cell 204b, one or more side lobes representing local maxima of signal intensity. For example, the private cell 204b is associated with side lobes 216 where the received gain of the beam 202b is relatively high. If another terrestrial device 206 assigned to the frequencyfi is located in a side lobe 216, that terrestrial device 206 may erroneously receive and process downlink data for the terrestrial device 206b.

Accordingly, in some implementations, beamforming is performed (e.g., gains and/or phases of the individual beams 214 are determined) such that, when a second terrestrial device shares a channel/frequency with a first terrestrial device, a beam for the first terrestrial device has a null at the location of the second terrestrial device. A null is a region receiving little or no signal intensity from a given beam, such as a region having a local or global minimum of the signal intensity. For example, beam 202b forms a private cell 204b (localized on the location of the terrestrial device 206b), side lobes 216, and nulls 208. In some implementations, the nulls 208 receive less than 1/10 the power, less than 1/100 the power, or less than 1/1000 the power of the beam 202b as is received at the private cell 204b. The nulls 208 are configured to be located at a location of terrestrial device 206a, which shares the frequencyfi with the terrestrial device 206b. Presence of the side lobes 216 is suppressed at the location of the terrestrial device 206a. The terrestrial device 206b, in turn, receives a beam 202a forming a private cell 206a localized at the location of the terrestrial device 206b. For visual clarity, side lobes and nulls of the beam 202a are not shown; however, a null of the beam 202a can be located at the location of the terrestrial device 206b, to reduce or prevent transmission of downlink data for terrestrial device 206a by terrestrial device 206b.

By contrast, terrestrial devices assigned to different channels/frequencies may, in some implementations, be located at one another's private cells and/or side lobes. For example, as shown in FIG. 2, beam 202c carries downlink data for terrestrial device 206c at frequency f₂, forming a private cell 204c at the location of terrestrial device 206c. Because terrestrial devices 206a, 206c are assigned to different channels/frequencies, terrestrial device 206c can be located at a side lobe 216 formed by beam 202b, without compromising signal reception fidelity by terrestrial device 206c. Permitting this type of device and private cell/side lobe overlap can ease the constraints involved in beamforming by the gateway device 112 and cluster 102, allowing for more efficient performance of beamforming calculations and/or more efficient signal transmission.

As terrestrial devices 206 move in the system 100 and as additional terrestrial devices 206 request service (e.g., request data, perform a phone call, are switched on, etc.), beamforming can be performed dynamically to determine new gains and/or phases for the individual signals 214. The new gains and/or phases result in private cells 204 that track moving terrestrial devices 206, the formation of new private cells 204 for new terrestrial devices 206, and the relocation of beam nulls/side lobes to accommodate terrestrial devices receiving data at the same frequency and, in some implementations, at the same time. The ability to perform this type of dynamic beamforming, in some implementations, is linked to the use of the cluster 102 of mobile platforms 104, which has sufficient spatial extent and mobile platform density to flexibly and dynamically create private cells on an as-needed, per-device basis. In some cases, other schemes that do not rely on clusters (such as beamforming by tower-based antennas) may not be able to match the highly parallel and dynamic private cell generation provided by some implementations of this disclosure.

In some implementations, respective beams 202 for terrestrial devices 206 assigned to the same channel/frequency may be transmitted at different timeslots (“hopping”), so that private cells of the terrestrial devices 206 may overlap without causing interference or incorrect signal reception. For example, for two terrestrial devices receiving signals of a common frequency f, at a first time, a private cell can be formed at the location of the first terrestrial device to transmit downlink data to the first terrestrial device. At the first time, the second terrestrial device may not be in a beam null (e.g., may be in the private cell or an associated side lobe) without negative results, because the second terrestrial device is not receiving data at the first time. During a second time, a private cell can be formed at the location of the second terrestrial device to transmit downlink data to the second terrestrial device. At the second time, the first terrestrial device may not be in a beam null (e.g., may be in the private cell or an associated side lobe) without negative results, because the first terrestrial device is not receiving data at the second time. Coordination of timeslots can be performed in a handshaking process or other suitable process.

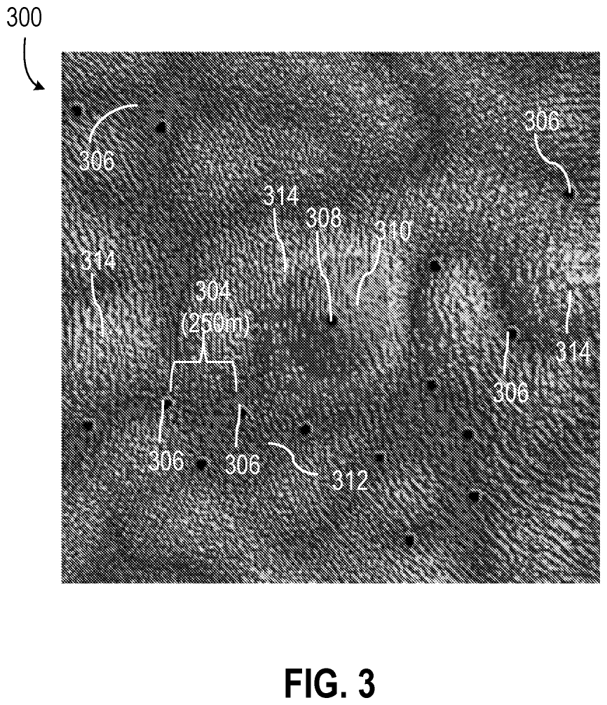

FIG. 3 illustrates a simulated example of beamforming in a system 300. The beamforming example of system 300, in some implementations, represents an example of beamforming in the system 100, e.g., as described with respect to FIG. 2. A private cell 310 is spatially localized at a location of a particular terrestrial device 308, the private cell 310 formed by a beam carrying downlink data for the terrestrial device 308. Other terrestrial devices, such as other terrestrial devices 306, share the same channel/frequency as the particular terrestrial device 308 (devices on other channels/frequencies may be present but are not shown in FIG. 3). In some implementations, the other terrestrial devices 306 also share a timeslot with the particular terrestrial device 308, e.g., receive downlink signals at the same time. Shading in FIG. 3 illustrates the gain of the beam that forms the private cell 310. Beamforming is performed to form nulls 312 at the locations of the other terrestrial devices 306, to reduce interference between shared-frequency transmissions. Side lobes 314 are present but are suppressed over the locations of the other terrestrial devices 306.

The density of terrestrial devices and the coverage region corresponding to a given cluster depend on the characteristics of the cluster, such as number of mobile platforms in the cluster and density of mobile platforms in the cluster. In the example of FIG. 3, terrestrial devices sharing a frequency/channel and sharing common signal reception times may be located a minimum distance 304 from one another of 250 meters. In various implementations, the inter-device spacing for the devices can be another distance, such as at least 50 m, at least 100 m, or at least 200 m. In some implementations, the inter-device spacing for the devices sharing a frequency/channel and sharing common signal reception times is less than 500 m. In some implementations, private cell diameter can be, for example, between 10 m and 50 m, such as between 15 m and 25 m. The coverage region covered by a mobile platform cluster may have a dimension (e.g., diameter or width) of between 10 km and 400 km, e.g., between 100 km and 200 km. The dimension of the coverage region can be determined, for example, based on the frequencies to be used for downlink signal transmission, the aperture size of each mobile platform (e.g., 0.5 meters) and the cluster size (e.g., spatial extent and/or mobile platform number). Accordingly, with the use of multiple channels and, in some implementations, timeslot separation for common-frequency devices, a given cluster can serve thousands, tens of thousands, hundreds of thousands, or millions of different terrestrial devices.

FIG. 4 illustrates an example of determination of a location of a terrestrial device in a system 400, e.g., so that a private cell can be formed at the determined location. Elements of the system 400 can correspond to elements described with respect to system 100. For example, a terrestrial device 404 can have some or all of the characteristics described for terrestrial devices 120a or 120b, and processes described with respect to FIG. 4 (e.g., location determination) can be performed by one or more elements of FIGS. 1-2, such as base station 112, mobile platforms 104, and/or terrestrial devices 120.

The terrestrial device 404 (in this example, a mobile device) transmits an uplink signal 408. The uplink signal 408 can include one or more types of data, such as a PN sequence, a pilot signal, an identification code, etc. In some implementations, the uplink signal 408 includes or indicates a request to receive data. In some implementations, the uplink signal 408 includes data to be sent to another device/system, e.g., through the network 110.

Multiple mobile platforms 104 in the cluster 102 receive the uplink signal 408 with different respective characteristics based on, for example, the different positions of the mobile platforms 104 and/or the different velocities of the mobile platforms 104 (e.g., resulting in Doppler effects). For example, mobile platform 104a receives a version 402a of the uplink signal 408 having gain (power) G₃ and phase φ₃, and mobile platform 104b receives a version 402b of the uplink signal 408 having gain (power) G₄ and phase φ₄.

Based on the different characteristics of the uplink signal 408 as received at different mobile platforms 104, the location of the terrestrial device 404 is determined. For example, in some implementations an angle of arrival (AOA) 410 of the terrestrial device 404 with respect to the cluster 102 is determined, e.g., the AOA 410 with respect to a central point or other predetermined location of the cluster 102. For example, the AOA 410 (and/or other indicator of the location of the terrestrial device 404) can be determined using a time difference of arrival (TDOA) method, a phase difference of arrival (PDOA) method, a triangulation algorithm, and/or another suitable method. In some implementations, a monopulse t method is used. In some implementations, the location is determined by an error minimization process, such as mean square error (MSE) minimization using an exhaustive search, a gradient descent process, or another suitable process. The AOA can be a two-dimensional direction of the terrestrial device with respect to the cluster 102.

In some implementations, one or more mobile platforms 104 of the cluster 104a determine the location of the terrestrial device 404. In some implementations, the uplink signal 408 and/or data characterizing the uplink signal 408 is transmitted from the cluster 102 to the gateway device 112. For example, mobile platforms 104 receiving the uplink signal 408 (which may be all or a subset of all of the mobile platforms 104 of the cluster 102) can perform pre-processing on the uplink signal 408, such as feature extraction, to determine one or more features (e.g., gain and/or phase) that are indicative of the location of the terrestrial device 404. These features can be included in gateway downlink data 410 transmitted from the cluster 102 to the gateway device 112 (e.g., as described for gateway downlink data 210). Alternatively, or in addition, the uplink signal 408 itself (e.g., different versions of the uplink signal 408 as received at different mobile platforms 104) can be included in the gateway downlink data 410. Based on the data in the gateway downlink data 410, the gateway device 112 can determine the location of the terrestrial device 404.

Based on the determined location, the gateway device 112 can perform beamforming calculations as described above (e.g., in reference to FIG. 2) and transmit, as gateway uplink data 412, commands causing formation of a private cell at the determined location. For example, the commands can indicate signals and signal parameters (e.g., gains and/or phases) to be transmitted by each of at least some of the mobile platforms, resulting in a private cell at the determined location, side-lobe suppression/nulls at locations of devices at the same frequency/channel, etc., as described in reference to FIG. 2. To form nulls at locations of devices at the same frequency/channel, the gateway device 112 can determine locations of the other devices (e.g., in the same manner described for terrestrial device 404) and perform beamforming calculations accordingly. When the mobile platforms 104 determine the location, the location can be included in the gateway downlink data 410 for subsequent use in beamforming calculations.

In some implementations, the determined location is a future location 406 of the terrestrial device 404. The future location 406 can be determined, for example, based on data indicative of movement of the terrestrial device 404 (e.g., positions of the terrestrial device 404 at multiple times, velocity of the terrestrial device 404, etc.). In some implementations, a predictive filter method (e.g., Kalman filter) and/or other suitable algorithm can be applied. The future location 406 can be a location at a future time t, and the gateway device 112 can transmit commands that cause the cluster 104 to form the private cell at the future location 406 at the time t. The use of a Kalman filter may further filter out signal noise, improving signal feature analysis.

In some implementations, the location of the terrestrial device 404 can alternatively or additionally be determined in another way. For example, in some implementations the uplink signal 408 directly includes an indicator of the location, e.g., coordinates of the terrestrial device 404 as determined using a GNSS sensor or other location sensor of the terrestrial device 404. In some implementations, a location at which to form a private cell is provided by a third party, e.g., over the network 110. The gateway device 112 can receive the location via the network 110 and perform beamforming calculations for forming a private cell, as described above, such that, in some implementations, uplink signals need not be received by the cluster 102 to initiate formation of a private cell at a location.

In some implementations, multiple clusters may be available to form a private cell for a given terrestrial device. For example, the terrestrial device may be in the coverage regions of two or more different clusters. In such cases, in some implementations, a process is performed (e.g., by one or more mobile platforms of one or more of the clusters, and/or by a gateway device) to select one of the clusters to use for beamforming.

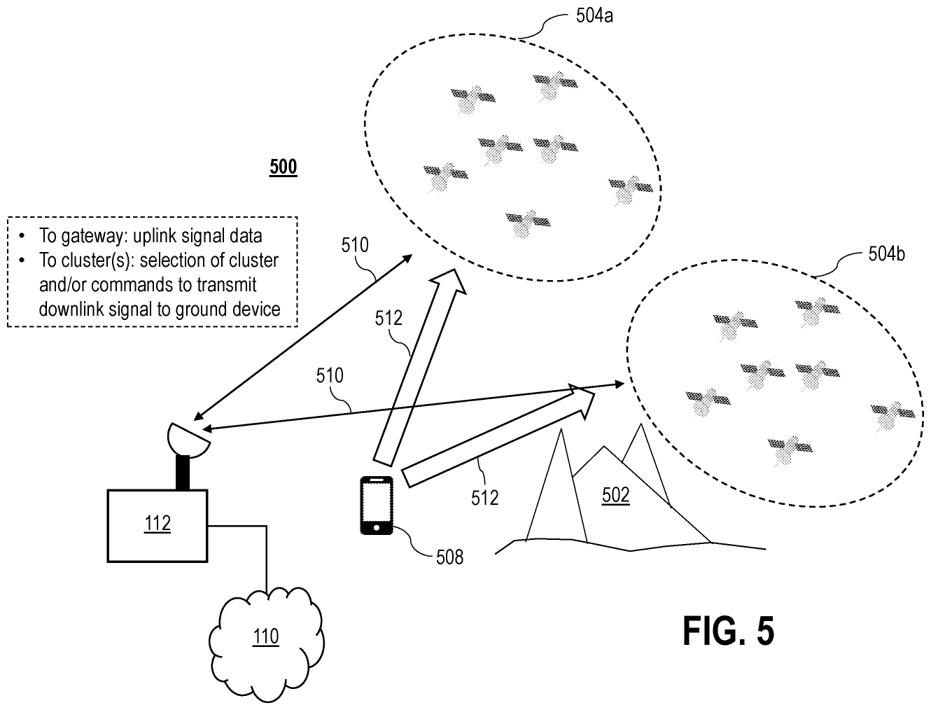

For example, as shown in FIG. 5, a system 500 includes a terrestrial device 508 within the coverage regions of two clusters 504a, 504b, either of which could be used to form a private cell at the location of the terrestrial device 508. Elements of the system 500 can correspond to elements described with respect to systems 100 and/or 400. For example, the terrestrial device 508 can have some or all of the characteristics described for terrestrial devices 120a or 120b; clusters 504a, 504b can have some or all of the characteristics described for cluster 102; and processes described with respect to FIG. 5 (e.g., cluster selection) can be performed by one or more elements of FIGS. 1-2, such as base station 112, mobile platforms 104, and/or terrestrial devices 120.

The terrestrial device 508 transmits an uplink signal 512 for receipt by the clusters 504a, 504b. Based on characteristics of the terrestrial device 508, the clusters 504a, 504b, and the system 500 (e.g., an environment in which the terrestrial device 508 and/or the clusters 504a, 504b are located), the uplink signal 512 is received differently by the two clusters 504a, 504b. The uplink signal 512 itself and/or features of the uplink signal 512 are sent from the clusters 504a, 504b to the gateway device 112 (510), which selects one of the clusters 504a, 504b based on the uplink signal data.

The selection can be performed based on one or more characteristics. In some implementations, the gateway device 112 determines or obtains a noise parameter (e.g., signal-to-noise ratio (SNR)) and selects the cluster having the more favorable noise parameter, e.g., higher SNR, because, exhibiting less noise in uplink signal reception, that cluster may be expected to perform downlink transmission with less noise.

In some implementations, the gateway device 112 determines a multipath fading metric and selects the cluster having the more favorable multipath fading metric. For example, a spectral shape of the uplink signal 512 can be used to determine fade volatility (e.g., one dominant ray or two dominant rays), the cluster with lower fade volatility is selected. The spectral shape of the uplink signal 512 can be useful for multipath fading estimation, because frequencies of uplink and downlink signals may be different, such that problematic multipath fading at a first frequency (e.g., the uplink frequency) may not be problematic at a second frequency (e.g., the downlink frequency), and vice-versa. The spectral shape of the uplink signal 512 can be used to estimate the amount of multipath fading for the downlink signal, even when a different frequency is to be used.

In some implementations, the gateway device 112 can select the cluster based on available resources of the cluster. For example, if the gateway device 112 determines that a cluster is already operating at or near capacity (e.g., forming private cells for as many, or almost as many, terrestrial devices as the cluster can support), the gateway device 112 can be less likely to select the cluster to provide additional private cells.

In some implementations, the gateway device 112 can select the cluster based on the environment of the system 500, such as based on line-of-sight between the terrestrial device (and/or a future location of the terrestrial device) and the clusters. For example, the cluster can be selected based on a presence of obstacles 502 between a cluster and the terrestrial device 508 or between a cluster and a predicted future location of the terrestrial device. A cluster having an interceding obstacle 502 may not be selected, because the obstacle 502 may interfere with downlink signal transmission.

In some implementations, a combination of these and/or other characteristics can be used to select the cluster. For example, a weighted combination of these and/or other characteristics can be used to assign each cluster a score, and a cluster having a highest or lowest score is selected. The gateway device 112 performs beamforming calculations for the determined cluster and transmits commands to the selected cluster to cause mobile platforms of the selected cluster to form a private cell for the terrestrial device 508 (510). In some implementations, the gateway device 112 transmits to the selected cluster, one or more non-selected clusters, or both, an indication of the selection (510).

As an example of dynamic operation according to some implementations of this disclosure, as a terrestrial device and/or a first cluster providing a private cell to the terrestrial device move with respect to one another, the gateway device can re-evaluate (e.g., periodically re-evaluate) whether the matching between the terrestrial device and the cluster is optimal. For example, in some cases, the terrestrial device may move outside the coverage region of the first cluster. In response, the gateway device can res-assign a second cluster to provide a private cell to the terrestrial device, and the resources of the first cluster can be re-assigned, e.g., to support private cell transmission for another terrestrial device.

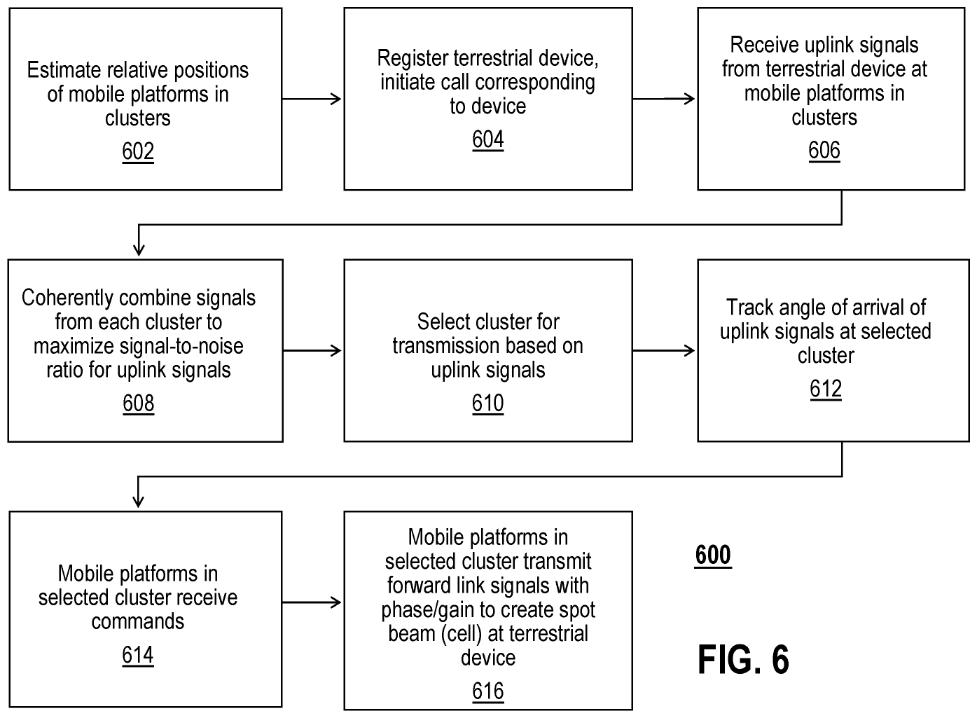

FIG. 6 illustrates an example of a process 600 of uplink signal reception, cluster selection, beamforming determination, and downlink signal transmission. Description provided with respect to elements of FIG. 6 can be applied in contexts beside the specific process 600, e.g., can be applied in the context of any of the implementations according to this disclosure, such as those of FIGS. 1-2 and 4-5. In addition, elements of the process 600 can be performed in a different order from that depicted. The process 600 can be performed, for example, by mobile platforms (e.g., mobile platforms 104) in one or more clusters (e.g., clusters 102 and 504a, 504b) in conjunction with a gateway device (e.g., gateway device 112).

In the process 600, relative positions of mobile platforms in one or more clusters are determined (602). The positions can be determined by the gateway device and/or by the mobile platforms, e.g., as described in reference to FIG. 1, such as using positioning signals transmitted between mobile platforms.

A terrestrial device is registered, and a call to or from the terrestrial device is initiated (604). For example, in some implementations, the gateway device receives (e.g., over the network 110) a request to place a call to a terrestrial device in a coverage region of one or more clusters communicably coupled to the gateway device, or the gateway device receives, via one or more clusters, a call request from the terrestrial device. The terrestrial device may be “registered” in that the gateway device becomes aware of the terrestrial device and allocates resources (e.g., mobile platforms of one or more clusters) accordingly.

For example, in the case of the terrestrial device requesting initiation of the call, each cluster receives uplink signals from the terrestrial device and relays the uplink signals to the gateway device. The uplink signals can be, for example, random access channel (RACH) signals. The gateway device analyzes the uplink signals to identify content/data therein, such as a PN sequence and/or data indicative of a request from the terrestrial device. In some implementations, the gateway device determines one or more characteristics of the uplink signals (sometimes referred to as channel state information (CSI)), e.g., for subsequent determination of the location of the terrestrial device and/or for cluster selection. In this example, based on the uplink signals, the gateway device determines that the terrestrial device is performing a phone call, and the call is initiated by the gateway device. For example, the gateway device can transmit a request for the call over a backhaul network (e.g., network 110) so that another gateway device/base station transfers the call to a recipient of the call.

In some implementations, in response to the call being initiated, one or more relevant clusters (e.g., those clusters for which the terrestrial device is in the clusters' coverage regions) are notified of the registered terrestrial device. For example, the gateway device can transmit an approximate location of the terrestrial device to the clusters. In some implementations, the approximate location is determined based on a GNSS service, determined based on a mobile platform cluster that received a request from the terrestrial device, or determined based on an angle-of-arrival analysis as described above.

Although FIG. 6 uses the example of a call, the process 600 is applicable to other forms of data transfer, such as requests for retrieving a webpage, audio or video streaming, application data transfer, and/or transfer of other types of media and digital data.

Mobile platforms in the relevant clusters receive uplink signals from the terrestrial device (606). In some implementations, this process is performed prior to call initiation, e.g., when the terrestrial device initiates the call as described in reference to element 604. In some implementations, this process is performed after call initiation. For example, after the gateway device has received a request to place a call to the terrestrial device, mobile platforms in one or more clusters transmit downlink signals for receipt by the terrestrial device, and the terrestrial device responds by transmitting uplink signals. Receipt of the uplink signals can be performed as described in reference to FIG. 4.

The uplink signals (e.g., relayed from the clusters to the gateway device) are coherently combined, e.g., to maximize the signal-to-noise ratio of the combined signals (608). The combined uplink signals can be uplink signals received at multiple mobile platforms within a single cluster and/or multiple mobile platforms across multiple clusters.

Based on the uplink signals, a cluster is selected for downlink transmission (610), e.g., as described in reference to FIG. 5. For example, the cluster having the best signal-to-noise ratio for the combined signals from the cluster can be selected.

The angle of arrival for the uplink signals at the selected cluster is determined (612), allowing for determination of the precise location of the terrestrial device, e.g., as described in reference to FIG. 4. For example, the AOA can be determined based on phases of the uplink signals as-received at different mobile platforms of the selected cluster. The angle of arrival can be tracked over time, allowing for tracking of the location over time and, in some implementations, prediction of the future locations of the terrestrial device.

The gateway device determines signals to be transmitted by mobile platforms of the selected cluster and transmits commands to the selected cluster (e.g., directly and/or via a leader mobile platform). At least some of the mobile platforms in the selected cluster receive the commands (614) and, based on the commands, the mobile platforms transmit forward link signals (downlink signals) with phase and/or gain specified by the commands (616). The downlinks signals create a spot beam (private cell) at the location of the terrestrial device, the spot beam conveying data for the terrestrial device. Command transmission and downlink signal transmission can be performed, for example, as described in reference to FIG. 2.

Clusters can be configured with various parameters in different implementations. In some implementations, each cluster includes between ten and 1000 mobile platforms, e.g., between 100 and 300 mobile platforms. Within the diameter of each cluster (which may be, for example, at least 500 m, e.g., between 500 m and 2 km, such as 1 km), the mobile platforms can be pseudo-randomly distributed with a spacing between one another of several meters, e.g., four meters. In some implementations, the mobile platforms are separated from one another by at least two meters. Each mobile platform can be independently maneuverable (e.g., using a propulsion system for satellite mobile platforms) to maintain the inter-platform distances and keep the cluster a coherent whole.

A non-limiting example of a cluster includes 100 mobile platforms. Each mobile platform implements a bent-pipe protocol for transfer of signals between a gateway device and terrestrial platforms. Each mobile platform includes a 0.5 meter dielectric resonator antennas (DRA) array for performing 6 GHz Band transmission and reception. Moreover, each mobile platform includes a 10 cm, 60 GHz DRA array for high-bandwidth ISLs with 10 GHz bandwidth. The cluster provides a coverage beam with radius 65 km. For each channel, the cluster can support 300 terrestrial devices sharing the channel. The cluster can support 80,000 separate terrestrial devices.

Scaling each cluster to include more mobile platforms can, in some implementations, improve both bandwidth and spatial localization of private cells. For example, in some implementations, the effective aggregate power output (EIRP) by a cluster is proportional to the square of the number of satellites in the cluster, because (i) each additional mobile platform provides additional power P and (ii) each additional mobile platform allows for more efficient/effective beamforming towards each terrestrial device, e.g., a higher proportion of the total emitted power included in the private cell as opposed to, for example, undesired side lobes. In addition, the aggregate bandwidth (for uplink/downlink signal transmission) of a cluster is proportional to the number of satellites in the cluster. Moreover, in some implementations, a cluster with N mobile platforms can perform beamforming to create N-1 nulls, allowing for N-times re-use of the wireless spectrum, e.g., use of the same frequency/channel for N terrestrial devices at the same time.

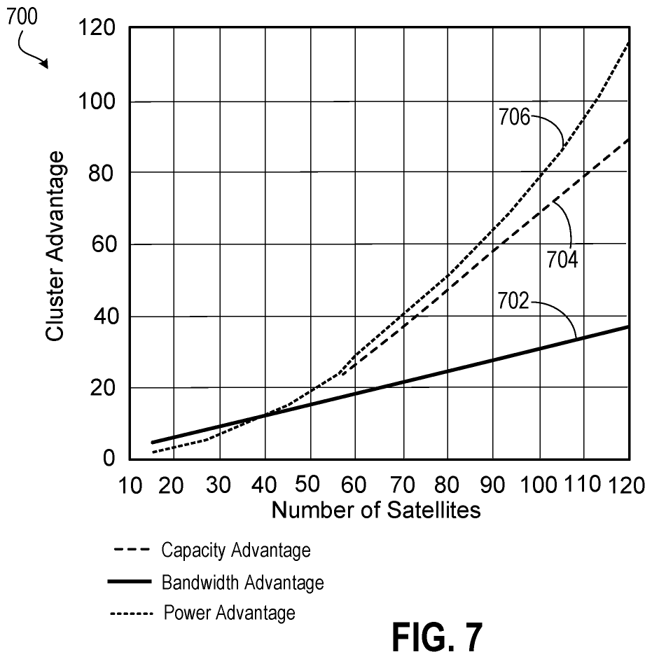

FIG. 7 illustrates simulated scaling advantages for device coverage using clustered mobile platforms (which are, in this example, satellites), as described herein, compared to single-satellite signal reception/transmission, e.g., using typical satellite telephone protocols. As the number of satellites increases, the power advantage 706 (EIRP, as described above) and capacity advantage 704 (associated with EIRP) increase super-linearly, while the bandwidth advantage 702 increases linearly. A 120-satellite cluster, for example, provides 37× aggregate bandwidth, 116× aggregate EIRP, and 89× capacity, compared to standard geosynchronous satellite network methods. In some cases, these and other advantages provided by the use of mobile platform clusters are associated with the comparatively wider area over which a mobile platform cluster may be spread, each mobile platform having its own power supply.

To service the entire Earth, a constellation of thousands of clusters and at least one million mobile platforms can be used. For example, the constellation can be composed of satellites positioned with an inclination between 50 degrees and 60 degrees, at an altitude between 500 km and 600 km.

Although the foregoing description sometimes refers to clustered mobile platforms that are entirely separate from one another, such as UAVs or satellites, in some implementations the clustered mobile platforms are integrated into a common device. For example, a sufficiently large satellite can include spatially-separated antennas (e.g., antennas separated from one another by at least several meters), the spatially-separated antennas being mobile platforms performing the functions described for mobile platforms in the foregoing description.

A number of implementations have been described. Nevertheless, it will be understood that various modifications may be made. Elements of one or more implementations may be combined, deleted, modified, or supplemented to form further implementations. In yet another example, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A method comprising:
determining a respective position of each of one or more mobile platforms of a plurality of mobile platforms forming a cluster, wherein the mobile platforms comprise aircraft or spacecraft; and
based on the respective positions of the one or more mobile platforms of the cluster, controlling each mobile platform of the one or more mobile platforms to transmit a respective signal, wherein a combination of the respective signals form a communications cell that is spatially localized at a location of a target terrestrial device, the communications cell configured to provide communications coverage for the target terrestrial device.

2. The method of claim 1, wherein controlling each mobile platform of the one or more mobile platforms to transmit the respective signal comprises:
determining, for each signal of the respective signals, a corresponding gain and phase,
wherein the gain and the phase of each signal are combined to cause the respective signals to form a beam spatially localized at the location of the target terrestrial device.

3. The method of claim 2, wherein the corresponding gain and phase are determined such that the beam has a null at a location associated with another terrestrial device.

4. The method of claim 3, wherein the other terrestrial device shares a communications cell frequency with the target terrestrial device.

5. The method of claim 2, wherein determining, for each signal, the corresponding gain and phase comprises:
receiving, at a gateway device, phase data characterizing reception of an uplink signal received at the cluster from the target terrestrial device;
based on the phase data, determining the location of the target terrestrial device;
based on the location of the target terrestrial device and the respective positions of the one or more mobile platforms, determining the corresponding gain and phase of each signal of the respective signals; and
transmitting, to the cluster, commands to cause the one or more mobile platforms to transmit the respective signals having the corresponding gains and phases.

6. The method of claim 1, comprising:
receiving, at the one or more mobile platforms, from a gateway device, data for the target terrestrial device,
wherein the respective signals encode the data for reception by the target terrestrial device.

7. The method of claim 1, comprising:
receiving, at the cluster, from the target terrestrial device, an uplink signal;
based on respective phases of the uplink signal as received at individual mobile platforms of the cluster, determining an angle of arrival of the uplink signal with respect to the cluster; and
based on the angle of arrival, determining the location of the target terrestrial device.

8. The method of claim 7, wherein the location of the target terrestrial device is a future location, and wherein determining the location comprises predicting the future location using a Kalman filter method.

9. The method of claim 1, wherein the one or more mobile platforms are one or more first mobile platforms, wherein the communications cell is a first communications cell, and wherein the method further comprises:
controlling each mobile platform of one or more second mobile platforms of the plurality of mobile platforms to transmit a respective signal, wherein a combination of the respective signals from the one or more second mobile platforms form a second communications cell that is spatially localized at a location of a second terrestrial device, the second communications cell configured to provide communications coverage for the second terrestrial device.

10. The method of claim 9, wherein at least one mobile platform of the plurality of mobile platforms is included in the one or more first mobile platforms and in the one or more second mobile platforms.

11. The method of claim 9, wherein the first communications cell and the second communications cell spatially overlap,
wherein the first communications cell is defined by a first beam having a first frequency, and
wherein the second communications cell is defined by a second beam having a second frequency that is different from the first frequency.

12. The method of claim 9, wherein the first communications cell and the second communications cell are spatially non-overlapping,
wherein the first communications cell is defined by a first beam having a particular frequency, and
wherein the second communications cell is defined by a second beam having the particular frequency.

13. The method of claim 1, wherein the plurality of mobile platforms forming the cluster comprises at least ten mobile platforms, and
wherein the at least ten mobile platforms are spatially distributed within a sphere having a diameter of at least 500 m.

14. The method of claim 1, wherein the one or more mobile platforms are a subset of the plurality of mobile platforms forming the cluster.

15. The method of claim 1, comprising selecting the cluster for signal transmission to the target terrestrial device from among a plurality of clusters, wherein selecting the cluster is based on at least one of:
a signal-to-noise ratio of an uplink signal received at the cluster from the target terrestrial device,
an estimate of downlink multipath fading, or
an estimated line-of-sight from the cluster to the target terrestrial device.

16. The method of claim 1, wherein the plurality of mobile platforms comprise satellites.

17. The method of claim 1, wherein the plurality of mobile platforms comprise a leader platform, and wherein the method comprises:
receiving, at the leader platform, commands from a gateway device; and
relaying the commands to the one or more mobile platforms, the commands causing the one or more mobile platforms to transmit the respective signals.

18. The method of claim 1, comprising:
determining, by a gateway device, the location of the target terrestrial device;
determining, by the gateway device, characteristics of the respective signals that cause the respective signals to form the communications cell; and
sending, to the one or more mobile platforms, from the gateway device, commands based on the characteristics of the respective signals, the commands causing the one or more mobile platforms to transmit the respective signals.

19. A system, comprising:
a cluster formed by a plurality of mobile platforms, wherein the plurality of mobile platforms comprise aircraft or spacecraft; and
a gateway device, wherein the gateway device is configured to:
determine a respective position of one or more mobile platforms of the plurality of mobile platforms; and
based on the respective positions of the one or more mobile platforms of the cluster, control each mobile platform of the one or more mobile platforms to transmit a respective signal, wherein a combination of the respective signals form a communications cell that is spatially localized at a location of a target terrestrial device, the communications cell configured to provide communications coverage for the target terrestrial device.

20. The system of claim 19, wherein controlling each mobile platform of the one or more mobile platforms to transmit the respective signal comprises:
determining, for each signal of the respective signals, a corresponding gain and phase,
wherein the gain and the phase of each signal are combined to cause the respective signals to form a beam spatially localized at the location of the target terrestrial device.

21. The system of claim 20, wherein the corresponding gain and phase are determined such that the beam has a null at a location associated with another terrestrial device.

22. The system of claim 21, wherein the other terrestrial device shares a communications cell frequency with the target terrestrial device.

23. The system of claim 20, wherein determining, for each signal, the corresponding gain and phase comprises:
receiving phase data characterizing reception of an uplink signal received at the cluster from the target terrestrial device;
based on the phase data, determining the location of the target terrestrial device;
based on the location of the target terrestrial device and the respective positions of the one or more mobile platforms, determining the corresponding gain and phase of each signal of the respective signals; and
transmitting, to the cluster, commands to cause the one or more mobile platforms to transmit the respective signals having the corresponding gains and phases.

24. The system of claim 19, wherein the gateway device is configured to:
transmit, to the one or more mobile platforms, data for the target terrestrial device,
wherein the respective signals encode the data for reception by the target terrestrial device.

25. The system of claim 19, wherein the gateway device is configured to:
based on respective phases of an uplink signal as received at individual mobile platforms of the cluster, determine an angle of arrival of the uplink signal with respect to the cluster; and
based on the angle of arrival, determine the location of the target terrestrial device.

26. The system of claim 25, wherein the location of the target terrestrial device is a future location, and wherein determining the location comprises predicting the future location using a Kalman filter method.

27. The system of claim 19, wherein the one or more mobile platforms are one or more first mobile platforms, wherein the communications cell is a first communications cell, and wherein the gateway device is configured to:
control each mobile platform of one or more second mobile platforms of the plurality of mobile platforms to transmit a respective signal, wherein a combination of the respective signals from the one or more second mobile platforms form a second communications cell that is spatially localized at a location of a second terrestrial device, the second communications cell configured to provide communications coverage for the second terrestrial device,
wherein
the first communications cell and the second communications cell spatially overlap, the first communications cell is defined by a first beam having a first frequency, and the second communications cell is defined by a second beam having a second frequency that is different from the first frequency, or
the first communications cell and the second communications cell are spatially non-overlapping, the first communications cell is defined by a first beam having a particular frequency, and the second communications cell is defined by a second beam having the particular frequency.

28. The system of claim 27, wherein at least one mobile platform of the plurality of mobile platforms is included in the one or more first mobile platforms and in the one or more second mobile platforms.

29. The system of claim 19, wherein the plurality of mobile platforms forming the cluster comprises at least ten mobile platforms, and
wherein the at least ten mobile platforms are spatially distributed within a sphere having a diameter of at least 500 m.

30. The system of claim 19, wherein the gateway device is configured to:
select the cluster for signal transmission to the target terrestrial device from among a plurality of clusters, wherein selecting the cluster is based on at least one of:
a signal-to-noise ratio of an uplink signal received at the cluster from the target terrestrial device,
an estimate of downlink multipath fading, or
an estimated line-of-sight from the cluster to the target terrestrial device.
